(19) United States
(12) Patent Application Publication
(10) Pub. No.: US 2025/0064251 A1
(43) Pub. Date: Feb. 27, 2025

(54) STEAM RECOVERY SYSTEM AND METHOD

(71) Applicant: ELECTROLUX PROFESSIONAL, INC., VICKSBURG, MS (US)

(72) Inventors: AJAY R. KOTHARI, Naperville, IL (US); NORWIN GLEN REGO, MANGALORE (IN); VIGNESH MURUGAN, COIMBATORE (IN)

(21) Appl. No.: 18/811,539

(22) Filed: Aug. 21, 2024

Related U.S. Application Data
(60) Provisional application No. 63/533,846, filed on Aug. 21, 2023.

(51) Int. Cl. A47J 27/16

(52) U.S. Cl. CPC A47J 27/16

(57) ABSTRACT

A steam recovery system and method for steam cooking, utilizing a secondary reservoir on top of a steam-based food cooker. The secondary reservoir is filled via a fill port with room temperature water from a water connection. A steam purge tube is connected from the top of the steam cavity of the cooker to the bottom of the secondary reservoir. Initially, water from a water source first fills the boiling apparatus then the secondary reservoir. Once steam generation begins part of the steam gets purged through the steam purge tube leading into the secondary reservoir. The steam is then condensed and loses heat into the water in the secondary reservoir, therefore heating up the water in the secondary reservoir. When the boiling apparatus is refilled, it is refilled with preheated water from the secondary reservoir. The secondary reservoir is then refilled from the water source.

### CROSS-REFERENCE TO RELATED APPLICATIONS

This application claims priority to U.S. Provisional Patent Application Ser. No. 63/533,846, filed Aug. 21, 2023, the entire disclosure of which is incorporated herein by reference.

### FIELD OF THE INVENTION

The present invention relates generally to foodservice steamer appliances. More specifically, the present invention is concerned with utilizing steam generated by an appliance to preheat water that is then used to refill the appliance's boiling apparatus that generates the steam.

### BACKGROUND OF THE INVENTION

In the foodservice industry, steamer appliances are commonly used to cook or re-thermalize various food products in large quantities using steam. For example, commercial foodservice providers frequently heat seafood, vegetables, other starches, and/or meats using commercial steamer appliances. Food steamer appliances have many advantages over alternative food heating methods, including but not limited to shorter cook times; more even heat penetration; gentler heat which does not burn or scorch food; more retained flavor, texture, moisture, and color; lower fat levels; and easier cleaning.

Currently available food steamer appliances typically include an enclosed cooking space, a water supply, a water boiling apparatus for generating steam, and a drain/vent system. There are three main types of commercial steamer appliances: boiler-based steamers, generator-based steamers, and boilerless steamers. The primary difference between these three types of steamers is the structure of water boiling apparatus utilized, with boiler-based steamers having an attached boiler, generator-based steamers having an integrated steam generator, and boilerless steamers having a compartment within its internal cavity configured for heating water to produce steam. In addition, boilerless steamers may include connection to a water line or may be connectionless and configured for being manually filled with water.

During operation of existing steamers, utilized steam is vented out of the system. Additional stray steam is condensed and drained out. The venting of the steam raises the ambient air temperature and humidity and increases the load on the kitchen HVAC system. Then, existing steamers use room temperature water from a typical water source to refill the boiling apparatus once needed. Refilling the apparatus with room temperature water reduces the water temperature and can cause steam generation to cease. Furthermore, extra energy is spent to raise the water temperature back to the steaming temperature. This venting/draining process followed by the refilling of the system with more water creates energy inefficiencies and other issues, such as recovery time.

Generally, boiler-based steamers have the fastest recovery times in between batches of food because of readily available steam in their attached boilers. Nevertheless, boiler-based steamers have the highest cost of ownership of commercial steamer appliances. Generator-based steamers typically have the next fastest recovery times and have a median cost of ownership. Boilerless steamers, are the cheapest to own but are generally the slowest to recover.

It would be beneficial to have a steam cooker with a steam recovery system and method that mitigates the raise in ambient air temperature and humidity, therefore keeping HVAC costs down. It would be beneficial to have a steam recovery system and method that did not require inefficient use of electricity to continually heat room temperature water for steaming. It would be beneficial to increase the recovery times in steam cookers, particularly for boilerless steams, which have the longest recovery time but are cheapest.

The present invention solves each of these problems. Heretofore, there has not been a steam recovery system and method with the advantages and features of the present invention.

### SUMMARY OF THE INVENTION

The present invention comprises a steam recovery system and method for steam cooking. In an embodiment of the present invention, the steam recovery system includes a secondary reservoir located on top of a steam-based food cooker utilizing a boilerless steamer. The secondary reservoir includes a fill port on the top and a drain port at the bottom. The secondary reservoir is filled via the fill port with room temperature water from a water connection. A steam purge tube is connected from the top of the steam cavity of the cooker to the bottom of the secondary reservoir. The steam purge tube includes a steam purge manifold with small holes for venting the steam out of the system.

During the initial start-up, water from a water source first fills the boiling apparatus then the secondary reservoir. Once steam generation begins part of the steam gets purged through the steam purge tube leading into the secondary reservoir. The steam is then condensed and loses heat into the water in the secondary reservoir, therefore heating up the water in the secondary reservoir. When the boiling apparatus is refilled, instead of being filled with room temperature water from the water source, it is refilled with the preheated water from the secondary reservoir. In turn, the secondary reservoir is refilled with the room temperature water from the water source. Then the heating cycle is repeated as needed.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 shows the system of the present invention according to some embodiments.

FIG. 2 shows the system of the present invention according to some embodiments.

FIGS. 3a and 3b show a valve according to some embodiments of the present invention.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In an exemplary embodiment, the steamer system is a boilerless steamer, and the water boiling apparatus includes a watertight water reservoir and a plurality of water heating elements or gas burners for heating water within the water reservoir to a boil to produce steam. Nevertheless, the present invention in other embodiments is also configured for any other type of steamer appliance, including but not limited to generator-based steamer embodiments and boiler-based steamer embodiments.

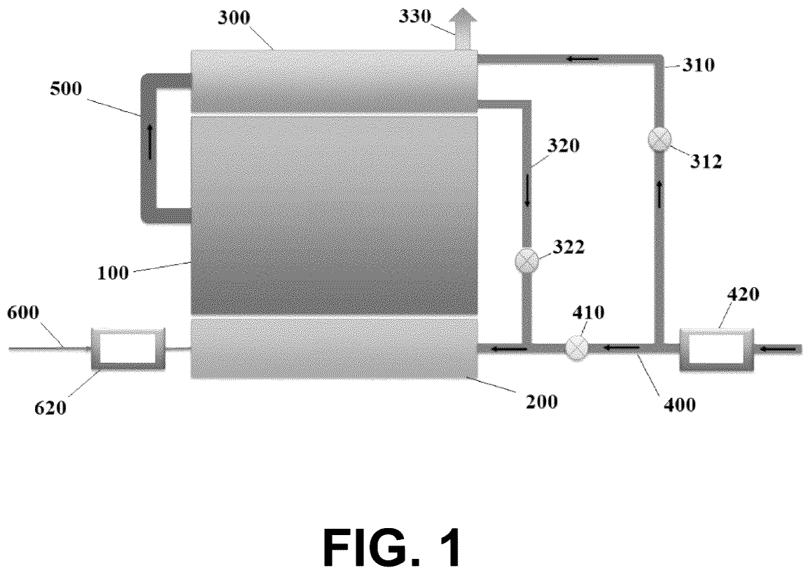

FIG. 1 shows an exemplary embodiment of the present invention. As seen in FIG. 1 there is a cavity 100, water boiling apparatus 200, and secondary reservoir 300. A main water line 400 is connected to a water source (not shown) at one end and the water boiling apparatus 200 at the other. A fill line 310 is connected from the main water line 400 at one end and the secondary reservoir 300 at the other. The fill line 310 is used to fill the secondary reservoir 300 from a water source and in the embodiment shown includes a fill valve 312. A drain line 320 is connected to the secondary reservoir 300 at one end and the main water line 400 at the other. The drain line is used to refill the boiling apparatus 200 with water from the secondary reservoir 300 and in the embodiment shown includes a drain valve 322. In the embodiment shown. the main water line 400 includes a main valve 410 in between the connection of the fill line 310 and water source on one end and the drain line 320 on the other. The main water line 400 also includes a water meter 420 in the embodiment shown. A steam purge tube 500 is connected from the cavity 100 to the secondary reservoir 300. Steam passes from the cavity 100 through the steam purge tube 500 to the secondary reservoir 300. The secondary reservoir 300 of FIG. 1 includes a steam vent 330. Finally, a power line 600 is connected to the water boiling apparatus 200 and is connected to a power source (not shown) at the other end. An energy meter 620 along the power line 600 is included in the embodiment in FIG. 1.

In an exemplary embodiment, the secondary reservoir 300 is located on top of the other parts of the steamer system such as in FIG. 1. It will be appreciated that the secondary reservoir could be located on the sides of the steamer system, below the steamer system, or any other configuration relative to the steamer system.

In some embodiments, the secondary reservoir 300 includes a fill port at the top of the reservoir and a drain port at the bottom of the reservoir. In some embodiments, the fill port is connected to the main water line 400 via the fill line 310 and is used to fill the secondary reservoir with water. The fill line 310 is optionally equipped with a fill valve 312 to control flow. In some embodiments, this is a manual fill valve. In some embodiments, the drain port is connected to the main water line 400 via the drain line 320, which leads into the water boiling apparatus 200. The drain line 320 is optionally equipped with a drain valve 322 to control flow. In some embodiments, this is a pinch valve. Heated water from the secondary reservoir 300 flows out of the drain port, through the drain line 320, and into the water boiling apparatus 200 for use in steam generation.

In some embodiments, the steam purge tube 500 is connected from the top of the steam cavity of the steam cooker to the bottom of the secondary reservoir. Excess steam from the cavity passes through the steam cavity to the secondary reservoir, heating the water. In some embodiments, the steam purge tube 500 includes a steam purge manifold with small holes for venting any remaining excess steam out of the system. In some embodiments, the secondary reservoir 300 includes a steam vent 330.

In some embodiments, the water boiling apparatus 200 is placed below the cavity 100 and is attached to a power line 600 and a main waterline 400. In some embodiments, an energy meter 620 and water meter 420 are connected. In some embodiments, the main water line 400 from the water source is equipped with a main valve 410 to control flow. In some embodiments, this is a solenoid valve. The boiling apparatus can therefore draw water from either than main water source or the secondary reservoir depending on which valve is engaged. The boiling apparatus uses the water to generate steam, which rises or otherwise enters into the cavity.

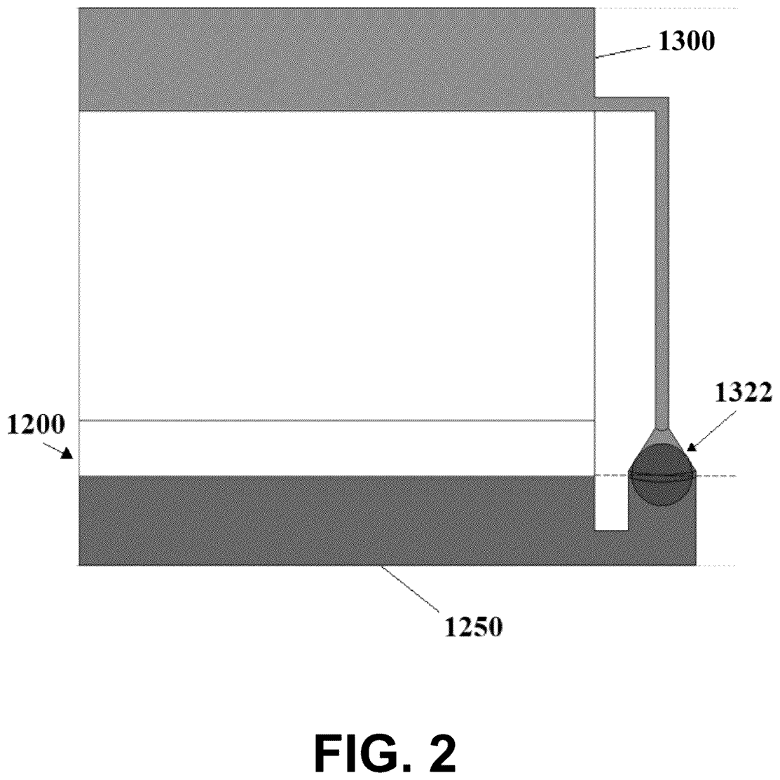

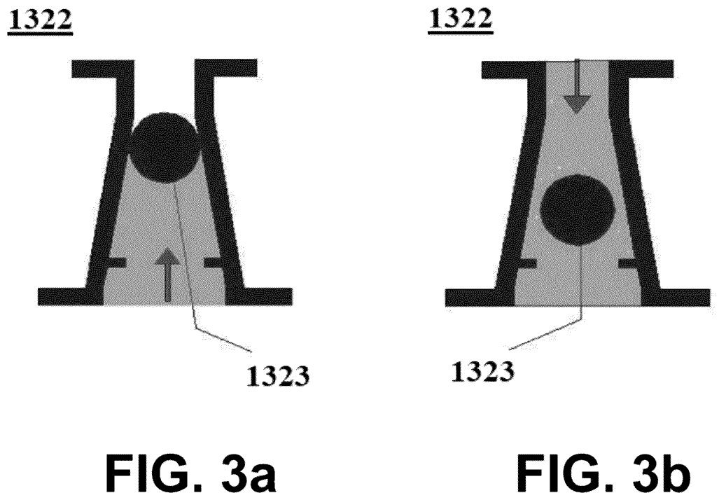

In some embodiments, such as shown in FIG. 2, the water boiling apparatus 1200 includes a boiler reservoir 1250. The boiling reservoir 1250 is filled with water that is then heated into steam for the system. In these embodiments, the boiling reservoir is connected to the secondary reservoir 1300 and the main water source. In some embodiments the valve 1322 between the secondary reservoir and boiler reservoir is a ball float and cup valve, as seen in FIGS. 3a and 3b. This valve allows the system to maintain water level at a desired level in all reservoirs utilizing a floating ball 1323. In some embodiments, the ball float and cup valve causes the secondary reservoir to be filled first.

In some embodiments, the boiler reservoir has an overflow port. In some embodiments, this overflow port is on the bottom of the boiler reservoir. In some embodiments, a modified U-bend overflow pipe with a vent is used. Therefore, when boiler water level reaches level of the inner dimeter of the U-bend, it will flow out due to siphon action. When water level goes below U-bend level, flow stops as U-bend vent breaks vacuum. During operation, since overflow port is underwater, stray steam does not leak out.

It will be appreciated that in addition to systems, methods for recovering steam vaper for repurpose is disclosed herein. In an exemplary embodiment, during the initial start-up of the system, water from a water source first fills the water boiling apparatus and the secondary reservoir with room temperature water. In some embodiments, this includes the boiler reservoir. Then the first cycle of steam generation begins and the room temperature water is heated by the boiling apparatus. The steam is used for cooking and then part of the steam gets purged through the steam purge tube leading toward the secondary reservoir. The steam is then condensed and loses heat into the water in the secondary reservoir, therefore heating up the water in the secondary reservoir.

After the initial cycle, the boiling apparatus will need to be refilled with additional water. Now, instead of drawing room temperature water from the water source, the boiling apparatus will refill with the preheated water from the secondary reservoir. Less energy and time is now required to heat the preheated water to a high enough temperature to generate steam. Additionally, there is less down time to steam generation, or down time may be eliminated altogether.

After the preheated water from the secondary reservoir fills the boiling apparatus, the secondary reservoir is refilled with the room temperature water from the water source. Then the heating cycle is repeated and once again the room temperature water in the secondary reservoir is heated by the excess steam being generated by the boiling apparatus. Furthermore, less steam and/or cooler steam is being vented into the air because of its use in heating the secondary reservoir. Therefore, there is less increase to ambient temperature and humidity, or this increase may be eliminated altogether.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a“, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially,” “approximately,” and similar terms of degree mean more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A steam recovery system, the system comprising:
a cavity configured to receive steam;
a water boiling apparatus connected to a main water line, said water boiling apparatus configured to produce steam from water for use in said cavity;
a reservoir configured to receive water, said reservoir connected to said main water line by a fill line and said boiling apparatus by a drain line; and
a steam purge tube connecting said cavity with said reservoir, wherein said steam purge tube is configured to collect excess steam from the cavity and transfer it to water in the reservoir thereby heating the water in the reservoir,
wherein said water boiling apparatus is configured to use heated water from said reservoir to produce steam.

2. The system of claim 1, wherein the drain line includes a drain valve.

3. The system of claim 2, wherein the drain valve is a pinch valve.

4. The system of claim 2, wherein the drain valve is a ball float valve.

5. The system of claim 1, wherein the fill line includes a fill valve.

5. The system of claim 5, wherein the fill valve is a manual fill valve.

6. The system of claim 1, wherein said water line includes a main valve configured to allow water flow from either the reservoir or an outside water source.

7. The system of claim 6, wherein said main valve is a solenoid valve.

8. The system of claim 1, wherein said reservoir further includes a steam vent.

9. The system of claim 1, wherein said steam purge valve further includes a purge manifold for expulsion of excess steam.

10. The system of claim 1, wherein the water boiling apparatus includes an overflow pipe.

11. The system of claim 10, wherein the overflow pipe is U-shaped.

12. The system of claim 1, further including a water meter connected to said main water line.

13. The system of claim 1, wherein the water boiling apparatus is a boilerless steamer.

14. A steam recovery method, the method comprising:
filling a water boiling apparatus with water from a water source;
filling a reservoir with water from said water source
boiling the water in the water boiling apparatus to produce steam for receipt by a cavity;
collecting used steam from said cavity;
transferring used steam to the water in the reservoir thereby heating the water in the reservoir; and
refilling said water boiling apparatus with heated water from said reservoir.

15. The method of claim 14, further comprising the step of refilling said reservoir with water from said water source.

16. The method of claim 14, further comprising the step of expelling excess steam from the reservoir.

17. The method of claim 14, further comprising the step of expelling excess water from the water boiling apparatus using an overflow pipe.

18. The method of claim 17, wherein said overflow pipe is U-shaped.

19. The method of claim 14, wherein the refilling of said water boiling apparatus is automatically controlled by a ball float valve.

20. The method of claim 14, wherein the water boiling apparatus is a boilerless steamer.
